(19) United States
(12) Patent Application Publication
(10) Pub. No.: US 2022/0135370 A1
(43) Pub. Date: May 5, 2022

(54) DEVICE FOR CALLING ELEVATORS

(71) Applicants: Gregory Kuker, Madison, WI (US); Amy Kuker, Madison, WI (US)

(72) Inventors: Gregory Kuker, Madison, WI (US); Amy Kuker, Madison, WI (US)

(21) Appl. No.: 17/518,738

(22) Filed: Nov. 4, 2021

Related U.S. Application Data
(60) Provisional application No. 63/109,559, filed on Nov. 4, 2020.

(51) Int. Cl. B66B 1/46; B66B 1/14; B66B 1/50; B66B 1/52; B66B 3/00

(52) U.S. Cl. CPC B66B 1/467; B66B 1/14; B66B 3/002; B66B 1/50; B66B 1/52; B66B 1/468

(57) ABSTRACT

A device that can be foot activated and used to call an elevator and/or control one or more functions of the elevator is disclosed. In particular, the user can step on one or more parts of the device to call an elevator to go to a floor located above or below a floor the user is currently located or to select specific floors. The device utilizes one or more air chambers/pockets that can be pressed to activate the sequence of air to travel through an air outlet of the air chamber/pocket, through an air hose, in order to activate switches on electrical contacts that are in electrical communication with the elevator call box. The electrical contacts are electrically connected to specific push buttons of an elevator to call and/or control specific elevator functions including ascending, descending, or traveling to a specific floor.

### CROSS-REFERENCE TO RELATED APPLICATIONS

This application is a non-provisional application which claims priority to U.S. Provisional Patent Application No. 63/109,559 filed on Nov. 4, 2020, which is incorporated by reference in its entirety.

### FIELD OF THE DISCLOSURE

This disclosure relates to a device that can be foot activated for a user to call an elevator. In particular, the user may step on or otherwise depress using another object or element one or more parts of the device to call an elevator to ascend/descend, or to go to a floor located above or below a floor the user is currently located or for controlling another function of an elevator. Further, in one or more non-limiting embodiments, the user may call the elevator to proceed to specific floors by stepping on the foot activated device having the intended floor number that relates to the floor a user wishes to travel to in the elevator.

According to one or more non-limiting embodiments, the foot activated device may include one or more air chambers/pockets that can be depressed (e.g., using one's foot or another object) to activate the sequence of air to travel through an air outlet of the air chamber/pocket, through one or more air hoses, and to one or more air activatable electrical contacts that are in electrical communication with the elevator call box of the elevator whose functions the user is trying to control using the device. The foot activated device may provide the user with another means to control one or more functions of an elevator other than using a hall station box or the push buttons on the elevator call box within the elevator. Further, the foot activated device may provide an alternative means for the user to call an elevator and control one or more functions of the elevator without necessarily having to use one's hands or fingers.

### BACKGROUND

Elevators are well-known apparatuses that help transport people to different floors. To use the elevator, it is well-understood to use the panel located on either the exterior or the interior of the elevator and press the button that takes the user to a desired floor. However, it is also true that many people may have their hands full as they go towards or into an elevator and it is difficult to press the push buttons using their fingers in such instances. The user often has to put down their items in their hands or have another person nearby select the buttons for them. Additionally, elevators are used by many people and there is legitimate concern about transferring germs or harmful viruses or bacteria that cause disease and illness by contacting the push buttons on an elevator with one's hands and fingers. Accordingly, there is a need for an alternative way to call an elevator and to control one or more functions of the elevator without necessarily having to use one's hands to push the buttons of the elevator to avoid such issues.

### SUMMARY

One or more non-limiting embodiments are presented herein for a device for controlling one or more functions of an elevator. The device may comprise a body having a top surface and a bottom surface and one or more air chambers incorporated into the body of the device. In a non-limiting embodiment, each air chamber relates to a specific function of the one or more functions, whereby the one or more air chambers are enclosed partitions configured to serve as pedals or buttons that control the one or more functions of the elevator. The device may further include one or more indicia that is visible on the top surface of the device having visible markings to indicate that an air chamber of the one or more air chambers is associated with a particular function of the one or more functions. The device may further include one or more air hoses, wherein the device is configured to allow air from the one or more air chambers to exit the one or more air hoses in order to control the one or more functions of the elevator, whereby the one or more air chambers is configured to be activated by a stepping action of a foot or by another force applied to the one or more air chambers from another object or element. In another embodiment, each air chamber of the one or more air chambers has a particular air hose of the one or more air hoses coupled to each air chamber. Further, the device may be configured to be placed or attached to a floor surface or a wall surface proximate to an exterior or interior of the elevator. Further, the device may be configured to be a continuous unit with multiple separated, enclosed air chambers for controlling multiple functions of the elevator. In other embodiments, the device may comprise a single, enclosed air chamber configured to control a single function of the one or more functions. The device may further include the one or more indicia comprise visible text, symbols, or other images conveying visual meaning about the one or more functions associated with controlling the elevator that can be selected using the device. In a non-limiting embodiment, the device may be a mat that can be placed on or otherwise attached to a floor surface or a wall surface.

In a non-limiting embodiment, the present description further includes description for a system for calling an elevator using an elevator calling device that may be foot activated in some embodiments. The system may include an elevator having an elevator call box comprising one or more buttons, whereby the elevator is disposed within an elevator hoistway. The system may further include an elevator calling device as described above. In a non-limiting embodiment, one or more air chambers are incorporated into the body of the device, whereby each air chamber relates to a specific function of the one or more functions, whereby the one or more air chambers are enclosed partitions configured to serve as pedals or buttons that control the one or more functions of the elevator. In a non-limiting embodiment, when the device is placed exterior to the elevator, the one or more electrical contacts are disposed within the electrical contact box and the one or more air hoses connects each air chamber of the device to the one or more electrical contacts within the electrical contact box. In a non-limiting embodiment, when the device is placed within an interior of the elevator, the one or more electrical contacts are disposed within the elevator call box and the one or more air hoses connects each air chamber of the device to the one or more electrical contacts within the elevator call box. In a non-limiting embodiment, the one or more functions associated with controlling the elevator comprise ascending, descending, selecting a specific floor to travel to, opening, and/or closing a door of the elevator. In a non-limiting embodiment, the one or more buttons of the elevator are tangible, physical items or are digital representations.

A method for calling an elevator using a (foot activated) controlling device is described according to one or more non-limiting embodiments. In a non-limiting embodiment, the method may include providing a device having at least one air chamber with an accessible exterior piece for depressing with a user's foot or other element in order to causing air from the at least one air chamber to travel to an associated air outlet of the device. The method may further include, responsive to depressing the at least one air chamber and causing the air from the air chamber to travel to the associated air outlet of the device, flowing air from the associated air outlet through at least one air hose. The method may further include flowing the air through the at least one air hose and to an electrical contact that is coupled with a button in an elevator call box of the elevator, wherein the electrical contact is disposed within an electrical contact box exterior to the elevator or within an elevator call box within the elevator, wherein the electrical contact is air activatable. The method may further include electrically communicating a signal from the activated electrical contact with a button of the elevator call box of the elevator, wherein the button of the elevator call box controls a particular function of the elevator.

Other aspects and advantages of the invention will be apparent from the following description and the appended claims.

### BRIEF DESCRIPTION OF THE DRAWINGS

The preceding and following embodiments and descriptions are for illustrative purposes only and are not intended to limit the scope of this disclosure. Other aspects and advantages of this disclosure will become apparent from the following detailed description.

Embodiments of the present disclosure are described in detail below with reference to the following drawings. The drawings described herein are for illustrative purposes only of selected embodiments and not all possible implementations and are not intended to limit the scope of the present disclosure.

FIG. 1 is a block diagram of a device for calling or otherwise controlling a function of an elevator in accordance with an illustrative embodiment.

FIG. 2 is a pictorial illustration of a first exemplary embodiment of a device that is in the form of a device for calling an elevator.

FIG. 3 is a pictorial illustration of a user stepping on the device shown in FIG. 2 which is used to call or otherwise control the elevator.

FIG. 4 is a pictorial illustration of a device located within an elevator to call an elevator to a specific floor.

FIG. 5 is a pictorial illustration of a device located on a terminal floor to call an elevator.

FIG. 6 is a pictorial illustration of a second exemplary embodiment of a device for calling or otherwise controlling an elevator in accordance with an illustrative embodiment.

FIG. 7 is a pictorial illustration of the device shown in FIG. 6 placed in front of an exterior wall of an elevator.

FIG. 8 is a pictorial illustration of an electrical contact box within an elevator hoistway with an air hose connected from the device shown in FIG. 7 to the electrical contact box in FIG. 8.

FIG. 9 is a pictorial illustration of the electrical contact box shown in FIG. 8 with the cover removed and the interior of the electrical contact box is visible.

FIG. 10 is a pictorial illustration of the electrical contact box within an elevator hoistway with an air hose connected from the device shown in FIG. 7 to the electrical contact box in FIG. 8 and the cover removed from the electrical contact box.

FIG. 11 is a pictorial illustration of a device located in front of an elevator call box and located in front of an interior wall of the elevator.

FIG. 12 is a pictorial illustration of an electrical contact box with air hoses of the device shown in FIG. 11 connected to the electrical contact box in the elevator hoistway.

FIG. 13 is a pictorial illustration of a disassembled elevator call box shown in FIG. 11.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with; and/or in the context of other particular aspects and embodiments of the invention; and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects.

The term “set” as used herein may refer to one or more. Accordingly, a set may include one item or several items.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any items, so a “set of items” may indicate the presence of only one item or may indicate more items. Thus, the term “set” may be equivalent to “one or more” as used herein.

The present description includes one or more embodiments for a device that may be used to control an elevator's functions. In one or more non-limiting embodiment, the device is foot activated, although another object or element other than a foot of a user may be used to apply a force to one or more pedals/buttons/air chambers on the device to control the elevator's functions. In a non-limiting embodiment, the device appears to be a mat that may be mounted or otherwise positioned on a floor surface or a wall surface either inside of or outside of a landing and/or hallway for an elevator. In a non-limiting embodiment, a user is able to step on the device and a specific section of the device or other type of device that indicates whether the user would like to go up, down, or to a specific floor in one or more non-limiting embodiments. In other non-limiting embodiments, the user may also press on a specific part of the device or other type of device to open or close the elevator doors from the exterior or interior of the elevator without using one's hands to push a corresponding button have the corresponding function on an elevator call box. Further, the device or other type of device as disclosed herein in one or more non-limiting embodiment includes indicia or indications of where to step to have an elevator move to the next floor up or the next floor down.

Alternatively, or additionally, a device as described herein may include numbers corresponding to floor levels and a user is able to step on the specific number included on the device with his or her foot (or using another object or element to provide a force to the enclosed air chambers/pedals/buttons), and the elevator is triggered to go to that specific floor. Additional details are provided below in reference to the Figures.

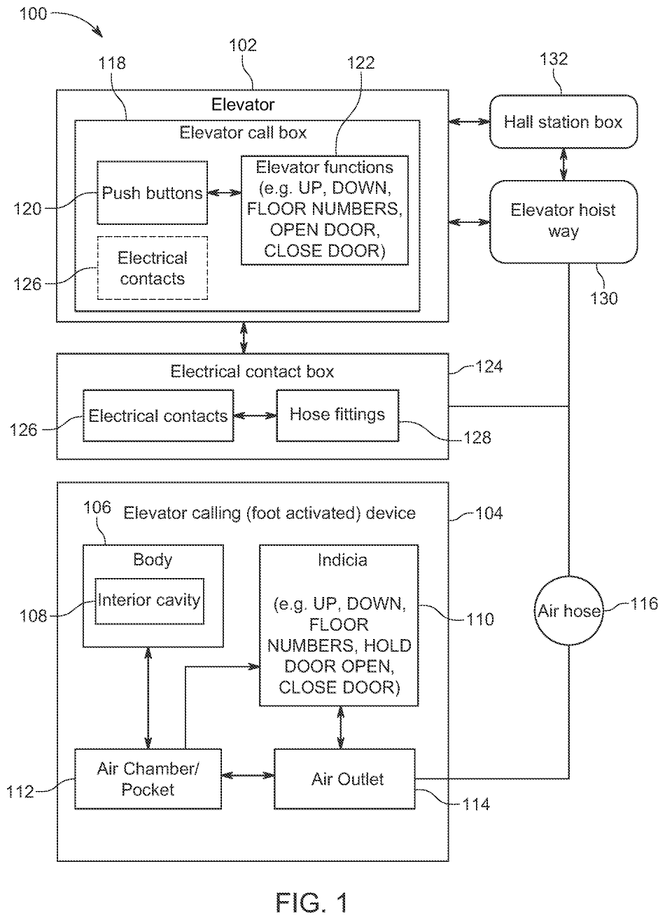

As shown in the block diagram of FIG. 1, system 100 as described herein includes a number of components, including elevator 102, elevator call box 118, elevator hoistway 130, electrical contact box 124, elevator calling (foot activated) device, and one or more air hoses 116. In one or more non-limiting embodiments, an elevator 102 may be located in any type of building structure, whether commercial or residential or any other type of building structure.

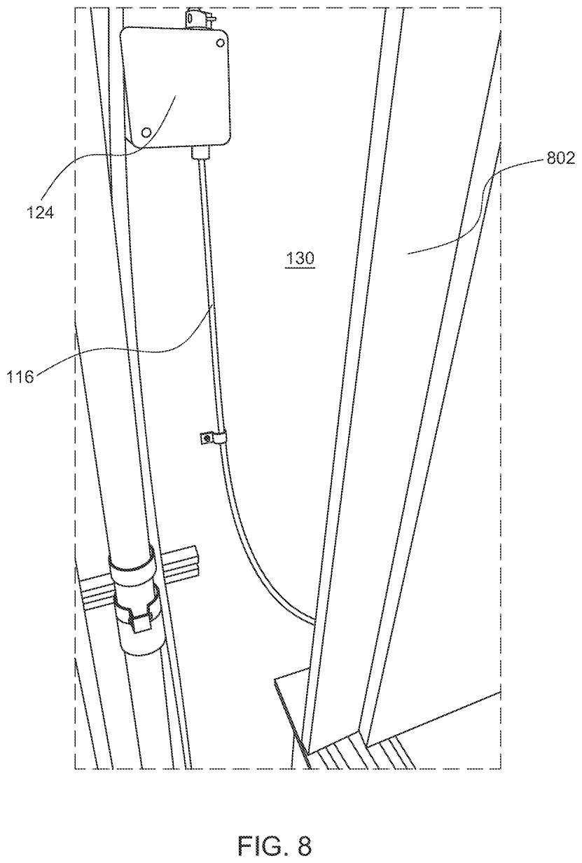

Elevator 102, also called a lift, is a type of car or vehicle that moves in a vertical shaft to carry passengers or freight between the levels of a multistory building. Elevator hoistway 130 is the enclosure for the vertical elevator shaft in which the elevator 102 is located in the building. An elevator landing is the portion of a floor, balcony, or platform adjacent to an elevator hoistway 130 which is used to receive and discharge passengers or freight. FIG. 8-9 and FIG. 12 show examples of an elevator landing 802.

Elevator call box 118 is a control box associated with the elevator 102 and may be located inside or outside of the elevator 102. The term “elevator call box” as used herein may interchangeably be used with “elevator car station box” or “car station box”. It is typical for the elevator 102 to include at least one elevator call box 118 on an inside of the elevator 102 with various push buttons, such as push buttons 120, that indicate to the user various functions 122 provided by the elevator 102. For example, the push buttons 120 include text and/or symbols indicating that the user can press a particular push button 120 in order to travel up or down or to a specific floor within a building. Further, the elevator call box 118 typically includes additional push buttons of relevance to the user, such as a “open door” push button 120 or a “close door” push button 120. It is noted that the elevator call box 118 or elevator hall station box 132 may have display screens or screen interfaces with digital buttons rather than typical tangible buttons. The term “push buttons” 120 as used herein is not limited to tangible, physical buttons and may include digital or virtual buttons as are located on screens.

Typically, conventional methods dictate that a user utilize the user's hands and fingers to press the push buttons 120 of an elevator call box 118 or hall station box 132 to select one or more buttons to control the functions 122 of the elevator 102. As noted above, this may be unhygienic or may be difficult for the user to perform using his or her hands if the user's hands are full and it is difficult at the time to reach the buttons of either the elevator call box 118 or the hall station box 132.

The elevator call box 118 typically may appear as a panel on an interior wall (usually at eye level of the user) of the elevator 120. The push buttons 120 are usually arranged on the elevator call box 118 and the user knows to select one or more push buttons 120 of the elevator 102 from the elevator call box 118 in order to control the elevator functions 122, including ascending, descending up or down a floor level or to select a particular level via the floor numbers, and to open and close the elevator doors. The push buttons 120 typically illuminate once they have been selected. The user typically selects the push buttons 120 using their fingers or another object in their hands. The elevator 102 may be used to transport people or things, including freight and packages.

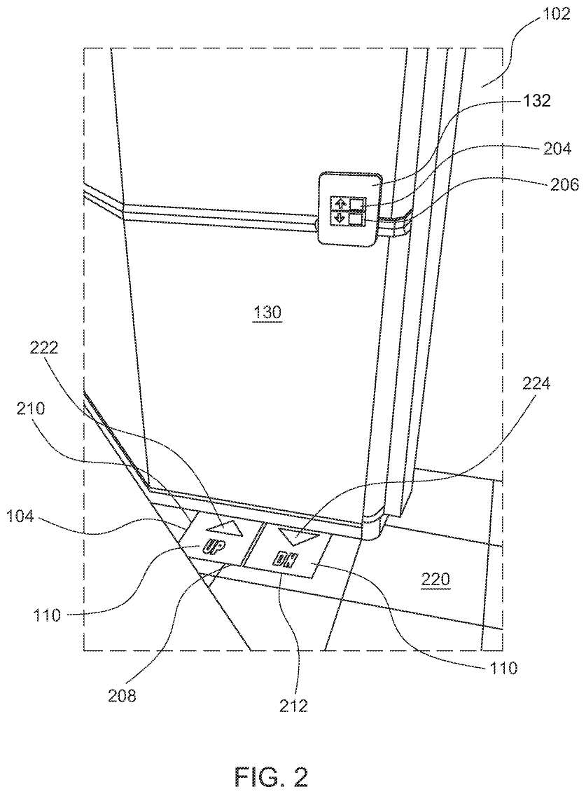

It is common a hall station box, such as hall station box 132, to be conventionally located on an exterior wall of the elevator hoistway 130 and for each elevator landing. The hall station box 132, as shown for example in FIG. 2, usually includes a number of push buttons (e.g., push buttons 204 and 206 shown in FIG. 2) that illuminate and include text or other symbols (e.g., arrows) to indicate whether a user may depress the push button to travel up or down in a building. Some hall station boxes 132 further include push buttons with numbers indicating a specific floor or level in a building. Hall station boxes 132 are usually featured on an exterior wall framing or defining the doors of the elevator 102 so that the user can select the buttons (e.g., buttons 204, 206) on the hall station box 132 to ascend, descend, open or close the doors of the elevator 102, or select another function 122 of the elevator 102 from an exterior of the elevator 102. Elevator call boxes 118 are usually located on an interior wall of the elevator 102 and accessible to the user from inside the elevator 102 when the user is already in the elevator 102. The user can access the push buttons 120 of elevator call box 118 for the elevator 102 from the inside and select one or more elevator functions 122 accordingly and as mentioned above using one's hands in the current conventional method of operation.

As uniquely described herein in one or more non-limiting embodiments, elevator calling device 104 is a device that may be used to call and/to control one or more functions 122 of the elevator 102. In one or more non-limiting embodiment, the device 104 may have a body 106 and may be in the form of a mat, but this is non-limiting. The device 104 may take other forms and shapes other than a mat and may still operate according to the one or more principles described herein and shown in FIGS. 1-13.

In a non-limiting embodiment, the elevator calling device 104 is foot activated. Further, in a non-limiting embodiment, the elevator calling device 104 may be in the form of a device configured to be foot operated or foot activated that a user may step on with one or more of the user's feet in order to control one or more elevator functions 122 so as to avoid having to call the elevator 102 or select another elevator function 122 using the user's hands and fingers. Stepping on such an elevator calling device 104 may allow the user not to have to worry about contracting diseases due to the spread of germs on the buttons of the hall station box 132 or elevator call box 118. Additionally, the user does not have to worry about dropping or shifting aside items in the user's hands. Rather, the user can call the elevator 102 to perform a particular function 122 of the elevator 102 by stepping on the foot activated elevator calling device 104. It is noted that in other embodiments, the user may alternatively use another object or element other than the user's foot to depress the enclosed air chambers/pockets 112, as further described below in one or more non-limiting embodiments, and control one or more functions 122 of the elevator 102.

Accordingly, instead of having to use a user's hands or fingers to push the push buttons 120 of an elevator call box 118 or on a hall station box 132, the user may step on a particular portion of the elevator calling device 104 and call the elevator 102 in order to go either up or down or travel to an intended floor in the building or control another elevator function 122 via the elevator calling device 104.

In a non-limiting embodiment, the elevator calling (foot activated) device 104 may have a body 106 that includes a top surface, bottom surface, and side surfaces. Exemplary, non-limiting elevator calling (foot activated) devices 104 are shown in FIGS. 2-13. The body 106 of the elevator calling (foot activated) device 104 may be generally rectangular shaped (e.g., as shown in FIGS. 2-5) in one or more non-limiting embodiment, although any other shape or configuration may be used in other embodiments. The size of the elevator calling (foot activated) device 104 may vary depending on how much text (i.e., indicia 110) is included on the elevator calling (foot activated) device 104. As shown in FIGS. 2-5, in which in some embodiments, the elevator calling (foot activated) device 104 is in the form of a mat, the mat may be wider or narrower depending on what is included on the top surface 210 of the device and/or mat 104 and the number of functions 122 of the elevator 102 that can be controlled via the device and/or mat 104.

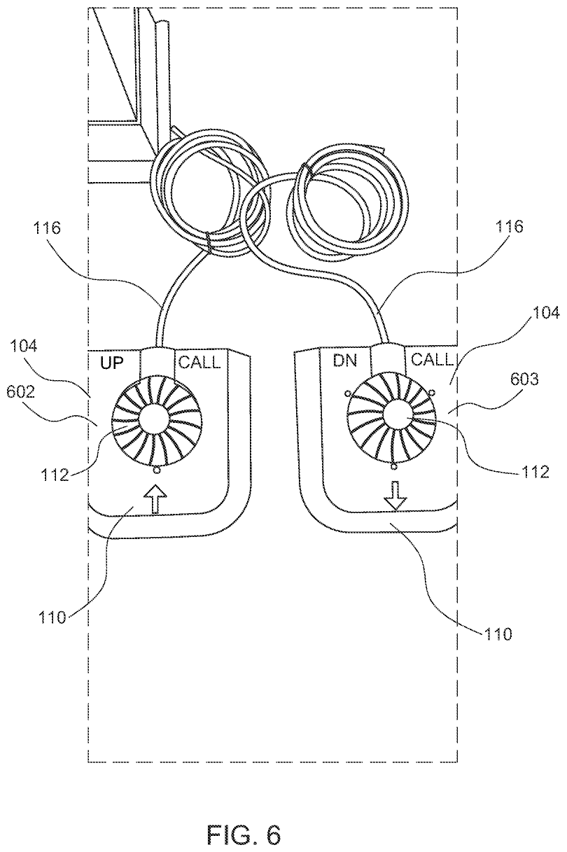

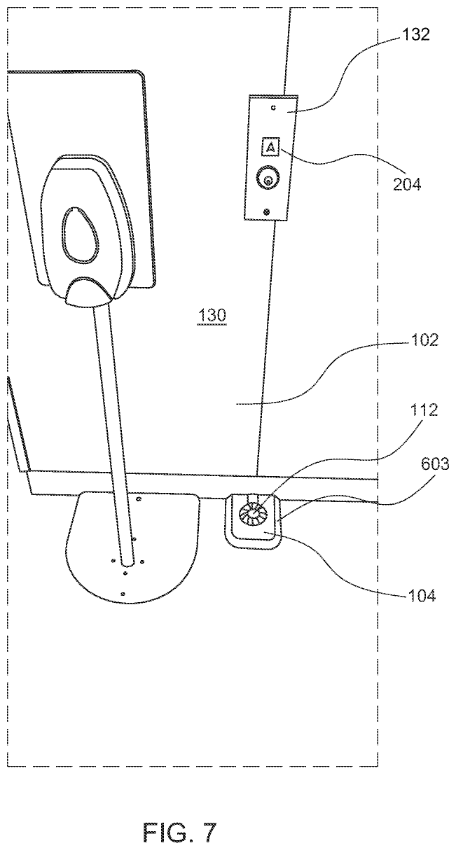

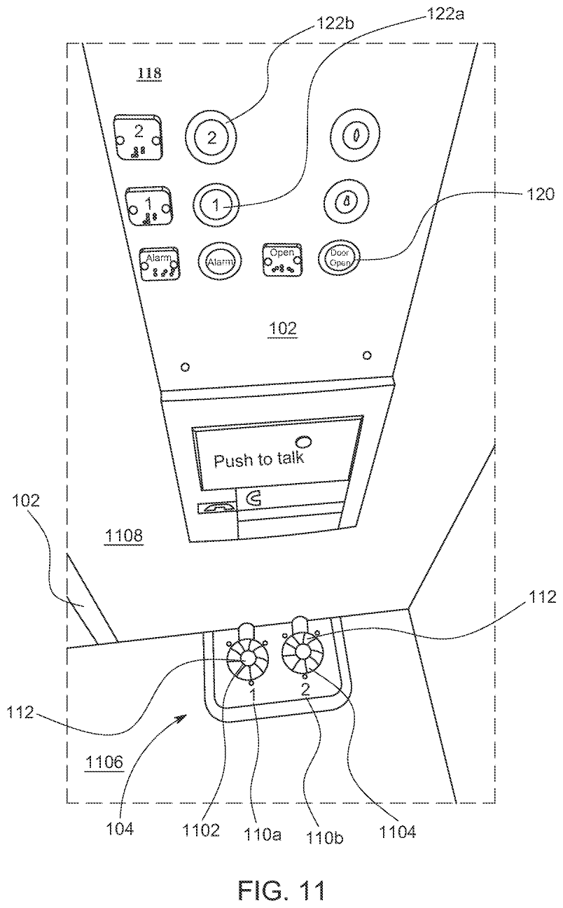

FIGS. 6-7 show a second embodiment of the elevator calling (foot activated) device 104, whereby the elevator calling (foot activated) device 104 is divided up into a first portion 602 having a narrow rectangular body that the user can step on to call the elevator 102 to move up a floor, as one exemplary function 122, and a second portion 603 having a narrow rectangular body that the user can press on to move down a floor, as another exemplary function 122. The elevator calling device 104 therefore is not contiguous in the exemplary secondary embodiment shown in FIG. 6, but rather is broken up into portions 602, 603 or separate units that can individually be stepped on and that have single air chambers/pockets 112 that are enclosed. More details are provided with respect to FIGS. 6-7 below. FIG. 11 shows an example of an elevator calling (foot activated) device 104 having two enclosed air pockets 112 that are adjacent to each other whereby a first air pocket 1102 controls ascent to a first floor and a second air pocket 1104 controls ascent to a second floor when a user steps on ether the first air pocket 1102 or the second air pocket 1104.

In addition to the above, elevator calling (foot activated) device 104 may include an interior cavity 108, in some non-limiting embodiments. In some embodiments, the air for various partitioned air chambers 112 may flow from the interior cavity 108 of the elevator calling (foot activated) device 104, but not in every case.

It is noted that the device 104 may be positioned on or otherwise mounted to the floor inside of or outside of the elevator 102. In other cases, the device 104 may be positioned on or otherwise mounted or attached to a wall surface inside of or outside of the elevator 102.

Air chambers 112, as used herein, may also be referred to herein as air pockets. Air chambers 112 are partitioned segments within the elevator calling (foot activated) device 104. In one or more non-limiting embodiments, each air chamber 112 is enclosed by an outer surface layer, cover, or partition. These partitioned areas of the elevator calling (foot activated) device 104 that enclose the air chambers 112 may also be referred to as pedals or buttons because the user can step on or otherwise force air from the air chambers 112 through the system shown in FIG. 1 in order to control the particular functions 122 of the elevator 102. In a non-limiting embodiment, each air chamber 112 is associated with a specific elevator function 122 of the elevator 102 that the user can control if a user steps on or otherwise activates the air chambers 112 of the elevator calling (foot activated) device 104.

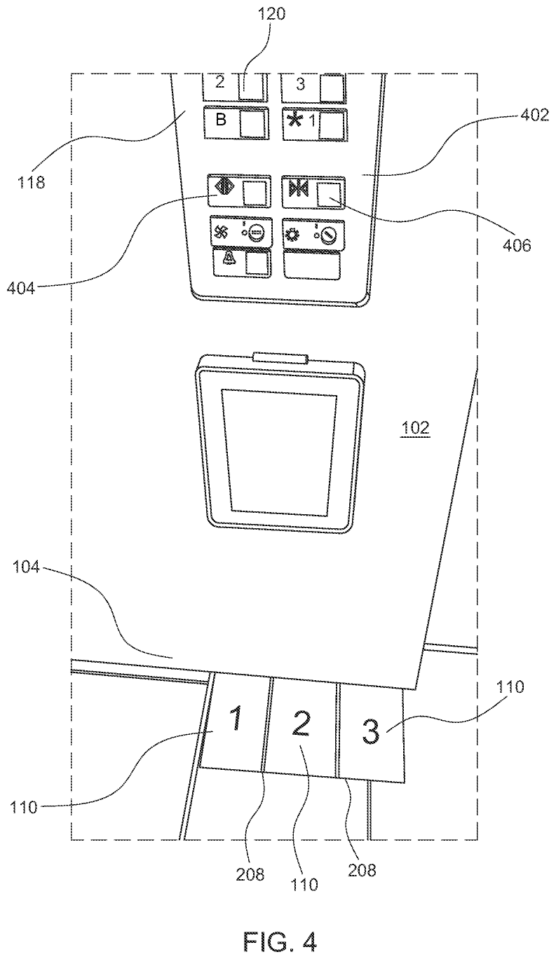

Each air chamber 112 is associated with indicia 110 as shown in the block diagram in FIG. 1 and as shown as examples in FIGS. 2-13. Indicia 110 is meant to mean “an indicator” of a particular elevator function 122. Indicia 110 may include text, symbols, pictures, or other visual indications displayed in various colors that have specific meanings. For example, indicia 110 may include the words “UP” or “DOWN” as shown in FIGS. 2-3 and 5. Further, indicia 110 may include arrows pointing up or down, as also shown in FIGS. 2-3 and 5. Additionally, indicia 110 may include numbers that represent specific floors or levels in a building, as shown in FIG. 4. Indicia 110 may thus include visible text, symbols, and/or various colors as well as other images or indications that visually convey meaning.

When displayed on device 104, the words “UP” or “DOWN” as represented may be accompanied by an arrow for each word. Further, the arrow for “DOWN” may be displayed in red colored text and the arrow for “UP” may be displayed in green colored text in order to comply with the color requirements for standard elevator codes. Visually, the colors red and green have a meaning assigned to them by standard elevator codes, and the elevator calling (foot activated) device may be in compliance with such codes. Further, the indicia 110 may include abbreviations that quickly convey a function. For example, as shown in FIG. 2, “DOWN” is abbreviated to “DN.” The “DN” text shown in FIG. 2 includes a red arrow beneath the “DN” text, which quickly conveys to the user that this is the “Down” segment of the device 104 on which a user may step on in order to call the elevator 102 to travel to a lower floor level. As further discussed in FIGS. 2-5, some elevator calling (foot activated) devices 104, including those in the form of a mat, may be dedicated to controlling only a select number of elevator functions 122.

Each air chamber 112 may include indicia 110 located on a top surface, such as top surface 210 of elevator calling (foot activated) device as shown in FIG. 2. The indicia 110 may be located above or below or to a side of a particular air chamber 112 and may be associated with a specific function 122 of the elevator 102. Accordingly, an air chamber 112 may be located above, beneath, or the side of the “UP arrow” 222 and indicia 110 with the text “UP” on device 104 shown in FIG. 2. Another air chamber 112 may be located above, beneath, or to the side of the “DN arrow” 224 and indicia 110 with the text “DN” on mat 104 shown in FIG. 2.

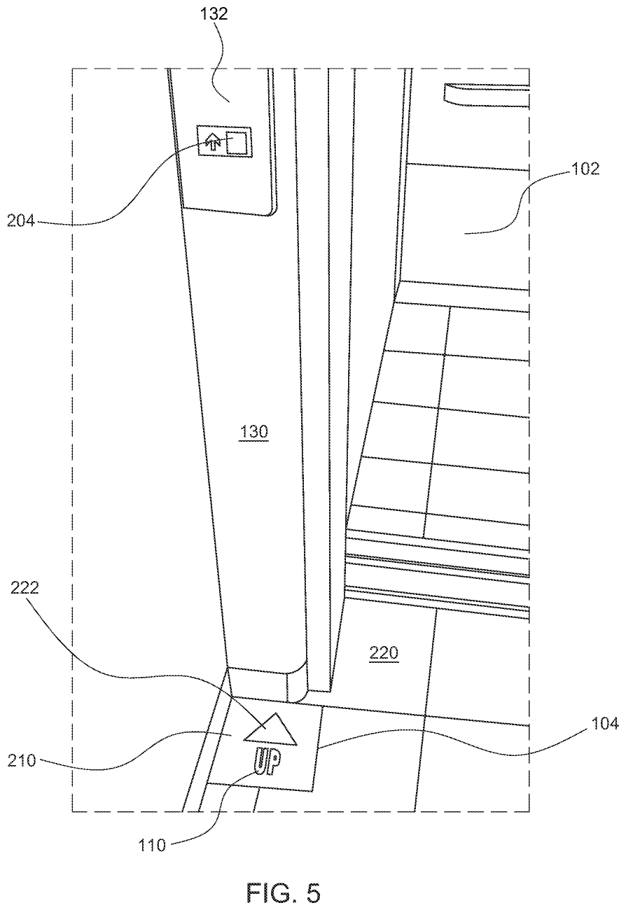

The number of air chambers 112 may correspond to the number of indicia 110 and number of elevator functions 122 that are controllable using mat 104. In some cases, there may be only one air chamber 112. For example, FIG. 5 shows a mat 104 having only one “UP” arrow 222. Accordingly, mat 104 in this embodiment may include a single air chamber 112 within the elevator calling (foot activated) device 104 and beneath the “UP” arrow 222. In other instances, the elevator calling (foot activated) device 104 includes more air chambers 112 that correspond with more elevator functions 122 that can be controlled using elevator calling (foot activated) device 104.

Each air chamber 112 may have an air outlet 114 that is accessible from each air chamber 112. The air outlet 114 is an outlet that serves to expel air contained in the air chamber 112. Each air outlet 114 may be coupled to an air hose 116. The air hose 116 may be a type of cable or tube connected to each respective air outlet 114 of the mat 104.

In a non-limiting embodiment, the air outlet 114 is the outlet/exit point where the air from the air chamber 112 exits the air chamber 112 and travels to the entrance of the air house 116. In some embodiments, the air hose 116 may be detachable. In other embodiments, the air hose 116 may not be detachable and may be permanently attached to the air outlet 114 and to the body 106 of the foot activated device 104. In a non-limiting embodiment, the air outlet 114 may be a small barbed outlet for the air hose 116 to attach. The air outlet 114 may protrude or stick out of a top surface, bottom surface, or side surface of the elevator calling (foot activated) device 104 and may be connected to the air hose 116. In a non-limiting embodiment, each enclosed or partitioned air chamber 112 may have a separate air hose 116 extending therefrom. In other non-limiting embodiments, there may be a single air hose 116 with multiple branches extending from the various enclosed air chambers 112 and going to either an electrical contact box 126 and/or an elevator call station 118.

In one or more non-limiting embodiments, the air hoses 116 may be removably detachable to the elevator calling (foot activated) device 104 or permanently attached to the elevator calling (foot activated) device 104. In a non-limiting embodiment, each air hose 116 may be a ¼ inch diameter hose, although these are only exemplary dimensions and the air hose 116 may be any other size/diameter in other embodiments.

Depending on the location and placement of the elevator calling (foot activated) device 104, the electrical contact box 124 may be used to serves as a location for the electrical hookup of the elevator calling (foot activated) device 104 and connection to the elevator call box 118. In one or more non-limiting embodiments, the electrical contact boxes 124 contain electrical contacts 126 that connect with wires to the electrical call box 118. Electrical contacts 126 act as micro processing switches that help to transmit electrical signals.

Typically, there are as many electrical contact boxes 124 in a building as there are elevator landings (e.g., elevator landing 802 as shown in FIG. 8). The electrical contact boxes 124 are usually attached to an interior concrete wall of the elevator hoistway 130, which is shown in FIGS. 8-10.

In a non-limiting embodiment, when the elevator calling (foot activated) device 104 is located in a hallway or on a landing that is exterior to the elevator 102, the air hoses 116 from the elevator calling (foot activated) device 104 may travel to an electrical contact box 124 and to specific electrical contacts 126 in the electrical contact box 124. That signal is then transmitted to the appropriate push button 120 in the elevator call box. In another non-limiting embodiment, when the elevator calling (foot activated) device 104 is located within an elevator 102 in order to control the elevator call box 118, such as that shown in FIG. 11, the electrical contacts 126 are included within the interior of the elevator call box 118 panel and the air hoses 116 of the elevator calling (foot activated) device 104 connect to the electrical contacts 126 included in the elevator call box 118. FIGS. 11-13 show an exemplary embodiment of such an example where the elevator calling (foot activated) device 104 is located inside of the elevator 102.

Accordingly, in a non-limiting embodiment, the elevator calling (foot activated) device 104 may operate by allowing air to travel from a specific enclosed air chamber 112, through the air outlet 114, through the air hose 116, to an electrical contact 126 that are in communication with push buttons 120 that control specific elevator functions 122. The electrical contact(s) 126 may be located in either an electrical contact box 124 attached to a wall surface or another surface of an elevator hoistway 130 or the electrical contact(s) 126 may be located within the elevator call box 118. When the air from the air traveling through the air hose 116 reaches a specific electrical contact 126, the air activates a switch on the electrical contact 126 that is momentarily toggled closed, thereby causing an electrical signal to communicate with a connected button 120 in the elevator call box 118. In this manner, the user may control the elevator 102's movements and actions using the elevator calling (foot activated) device 104. In this manner, the elevator calling (foot activated) device 104 may be an air activated device 104 that manipulates the air inside of each air chamber 112 to trigger controls/push buttons 120 of the elevator 102 and cause particular elevator functions 122 to occur. FIG. 6 shows an example of a device 104 having two bulbous protrusions 602, 603 that serve as air chambers 112 that contain air. In a non-limiting embodiment, the user may step on either bulbous protrusion 602, 603 that enclose the air chambers 112 and the air travels through the air hose 116 of each portion of the elevator controlled (foot activated) device 102 to the respective electrical contact 126 (whether in the electrical contact box 124 or in the elevator call box 118) that are in communication with the respective push buttons 120 of the elevator call box 118.

Electrical contact box 124 may be included as part of the system 100 for operating elevator 102 using the elevator calling (foot activated) device 104. In a non-limiting embodiment, the electrical contact box 124 may be mounted or otherwise positioned on an inside wall or other surface of the elevator hoistway 130 in one or more non-limiting embodiments. The electrical contact box 124 may include a number of hose fittings 128 that correspond to the same number of air hoses 116 that are connected to the air outlets 114 of each air chamber/pocket 112 of the device and/or mat 104. Each air hose fitting 128 may couple to each air hose 116 that extends from each air outlet 114 of the device and/or mat 104 that is associated with each air chamber 112. The number of hose fittings 128 may correspond to the number of air hoses 116 and air outlets 114 protruding from the device and/or mat 104 as well as the number of actual air chambers 112 contained within the device 104 in one or more non-limiting embodiments.

In one or more non-limiting embodiments, various fasteners can be used to fasten the air hoses 116 as they extend from the elevator calling device 104 to either an electrical contact box 126 or to an elevator call box 118. Each air hose 116 may be a cable/tube that can carry air from the air chambers 112 of the elevator calling (foot activated) device 104. FIG. 8 shows an example of a bracket being used to hold the air hose 116 against the wall of the elevator hoistway 130 while the air hose 116 is traveling to the electrical contact box 124. The small diameter air hose 116 may pass through the wall of the elevator hoistway 130 and will attach to one side of the electrical contact box 124, which as noted above, is mounted inside a wall of the elevator hoistway 130. In one example embodiment, the air hose 116 may be about 15 inches long as most elevator hoistway 130 walls are only about 8 inches deep. The air hose 116 may pass from the device 104 through the wall or floor of the elevator hoistway 130. FIG. 7 shows a non-limiting example of the device and/or mat 104 pushed up against an exterior wall of the elevator hoistway 130. The air hose 116 from the device and/or mat 104 can extend through the interior wall of the elevator hoistway 130 and be connected/attached to a specific electrical contact 126 of an electrical contact box 124 which then transmits the electrical signal from the electrical contact 126 to the hall station box 132 and to the elevator call box 118, which is shown in FIGS. 8-10.

In particular, the air hose 116 passes the air from the air chamber 112 of the device and/or mat 104 through the air outlet 114 and to the air hose fittings 128 of the electrical contact box 124 in a non-limiting embodiment. The air hose 116 may be cut to fit the specific size of the wall when the width of the elevator hoistway 130 walls is determined in the actual building where the elevator 102 is located.

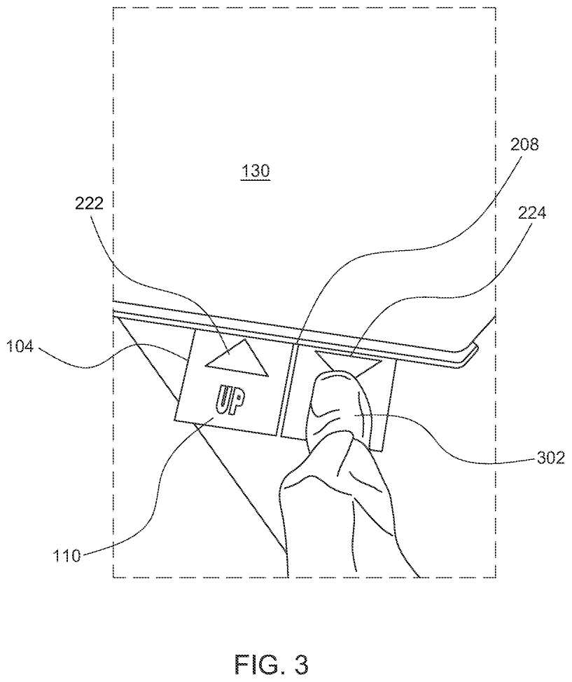

In one or more non-limiting embodiments, each air chamber 112 may be divided and partitioned from the adjacent air chamber 112 via an internal wall or border through which the air does not cross. As shown in FIG. 2, FIG. 3, and FIG. 4, visually on the top surface 210 of device and/or mat 104, there may be a visual divider line 208 that indicates to the user where to step on the device and/or mat 104 so as to avoid calling the elevator 102 to perform the wrong function by stepping on an incorrect air chamber 112. FIG. 6 and FIG. 7 show an alternative embodiment in which the elevator calling device 104 is not one continuous piece with visual divider lines 208 between the various indicia 110, but rather FIGS. 6-7 show that the elevator calling device 104 may be broken up into separate units 602, 603 having specific indicia 110 for a specific function.

In the examples shown in FIGS. 2-5, each air chamber may be 7 inches long by 7 inches wide, which helps to determine the dimensions of the device and/or mat 104. If, for example, two air chambers 112 are needed because two specific elevator functions 122 may be controlled using the device and/or mat 104, then the device and/or mat 104 may be 7 inches long by 14 inches wide to accommodate both air chambers 112. It is understood that these dimensions are just exemplary and may be altered from in other embodiments.

The electrical contact box 124 includes a number of electrical contacts 126. In one or more non-limiting embodiments, the electrical contacts 126 act as switches that can be toggled open and close when a user steps on a specific air chamber 112 associated with a specific electrical contact 126 (e.g., via the air hose 116). When a person steps on a specific air chamber 112, the air from that air chamber 112 is pushed through the air outlet 114 and through the air hose 116 coupled to the specific electrical contact 126 via the hose fitting 128. The hose fittings 128 may be small barbed hose fittings that stick out of one end of the electrical contact box 124 in order to couple to each air hose 116. In one or more non-limiting embodiments, the electrical contact box 124 may be about 4 inches long by 4 inches wide and 2 inches deep.

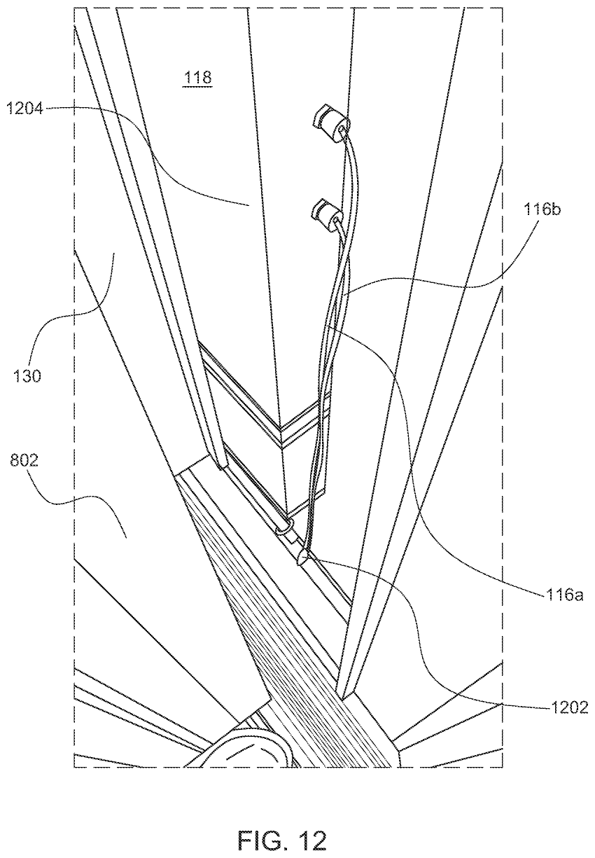

In a non-limiting embodiment, the electrical contact 126 may include a barb to which the exit end of the air hose 116 attaches. The barb on the electrical contact 126 may have a slip fit connection with the air hose 116 in order to connect one end of the air hose 116 to the electrical contact 126. It is noted that there may be multiple air hoses 116 extending from an elevator calling (foot activated) device 104 (e.g., as shown in FIG. 12) that extend from the elevator calling (foot activated) device 104 and travel to either the electrical contact box 124 (e.g., as shown in FIGS. 8-10) or to the elevator call box 118 (also known as car station 118) as shown in FIGS. 11-13.

In a non-limiting embodiment, the electrical contact 126 is a microprocessing switch with a barb on it that can attach to one or more air hoses 116. When the air from the air chamber 112 passes through the air hoses 116 over the electrical contact 126, the electrical contact 126 can be toggled closed momentarily, which sends an electric signal through the wires to the relevant push button 120 on the elevator 102 in order to control a particular connected function 122. The electrical contact 126 can be toggled open or close in one or more non-limiting embodiments.

The number of electrical contacts 126 located in the electrical contact box 124 may correspond to the number of air chambers 112. Accordingly, the electrical contact box 124 may have multiple electrical contacts 126. In some cases, as explained with respect to FIG. 4, the device and/or mat 104 may only have a single air chamber 112 (e.g., to correspond to an “UP” arrow 222 and to control the “UP” function of the elevator 102). Accordingly, the electrical contact box 124 may only include a single electrical contact 126. Alternatively, an electrical contact box 124 (or elevator call station 118) may include a plurality of electrical contacts 126 in case additional devices and/or mats 104 are provided later on in a building or switched out, and only the specific number of electrical contacts 126 are coupled to air hoses 116 as needed.

The electrical contacts 126 may be spring loaded in one or more non-limiting embodiments. The electrical contacts 126 may automatically return to a normally open state after the air actuation has occurred and when the user steps off of the mat 104. As noted above, when air is pushed through the attached air hose 116 from a specific air chamber 112 in the mat 104, that air travels through the air hose 116 to a specific electrical contact 126 which is toggled to a closed state when the air activates the electrical contact 126. In a normal state, the electrical contact 126 is open.

In a non-limiting embodiment, when utilized, the electrical contact box 124 may be in electrical communication via attached wires to the elevator call box 118. As noted above, the elevator call box 118 is the control entity that normally controls the operation of the elevator 102 in response to a push button 120 being pushed by a user's fingers. In one or more non-limiting embodiment, the electrical contact box 124 may include at least two terminal ends. Electrical wires or cords can be run from the electrical contact box 124 through the terminal ends of the electrical contact box 124 to the elevator call box 118.

In a non-limiting embodiment, each electrical contact 126 can have two wires that will hook or be connected in parallel to an existing push button 120 in the existing elevator call box 118. When the electrical contact 126 is closed (e.g., via the air activated device 104), the input is provided from the connected wires to a respective push button 120 in the existing elevator call box 118, and thus, the appropriate push button 120 is selected and illuminated in the elevator 102. In this manner, the electrical contacts 126 can trigger or activate an “UP” push button 120, a “DOWN” push button, or a specific number (e.g., 1, 2, 3, 4, etc.) push button 120 of the existing elevator call box 118. In this manner, using the device and/or mat 104, the user has selected a specific function 122 and corresponding push button 120 located on the elevator call box 118 in the elevator 102 and a hall station box 132 located on the outside of the elevator 102. The hall station box 132 and the elevator call box 118 are in electrical communication and the push buttons located on either the elevator call box 118 or the hall station box 132 can be triggered together by the air activated device 104 in one or more non-limiting embodiment.

In FIG. 2, an example of elevator calling (foot activated) device in accordance with the description provided in FIG. 1 is shown. As shown in FIG. 2, an elevator 102 is shown in a hallway of a building. The elevator 102 in FIG. 2 includes a hall station box 132 located on an exterior wall of the elevator hoistway 130, which encompasses the elevator 102. The hall station box 132 in FIG. 2 includes an “UP” push button 204 and a “DOWN” push button 206. The “UP” push button 204 and the “DOWN” push button 206 may conventionally be pushed or depressed by a user using his or her fingers to go up or down in the elevator 102 to another floor in the building. It is noted that the elevator 102 located on this floor of the building is located on an intermediate floor, in which there are one or more floors located either above or below this particular floor in the building where the elevator 102 is positioned.

Accordingly, the device and/or mat 104 includes indicia 110 of the device and/or mat 104 to move either “UP” or “DOWN” (e.g., “DN”). As shown in FIGS. 2-6, in some non-limiting embodiments, the device 104 may be positioned on or otherwise mounted to the floor inside of or outside of the elevator 102. In other cases, the device 104 may be positioned on or otherwise mounted or attached to a wall surface inside of or outside of the elevator 102.

Each indicia 110 is separated by a divider line 208, in a non-limiting embodiment, so that the user knows where to step on the device and/or mat 104. The device and/or mat 104 further includes an “UP” arrow 222 in green and a “DOWN” arrow 224 in red so as to comply with standard elevator codes as discussed above. The “UP” arrow 222 is positioned above the word “UP” and pointing up to further indicate to the user to use one's foot and step on this part of the mat 104 to control the elevator 102 and move up one or more floors. Similarly, the “DOWN” arrow 224 is positioned above the word “DN” and pointing downwards to further visually indicate to the user to use one's foot and step on this part of the device and/or mat 104 to control the elevator 102 and move down one or more floors.

It is envisioned that a device and/or mat 104 may be located as close to the elevator 102 as possible and may be flat on a floor surface 220 near or in front of the elevator 102. Preferably, the device and/or mat 104 is flush with or in contact with the bottom edge of the exterior wall of the elevator hoistway 130 or another wall next to the elevator 102. This way, the user is near to the elevator 102 when standing on the device and/or mat 104, but is still positioned off to the side in case anyone needs to enter or exit the elevator 102.

As shown in FIG. 2, the indicia 110 included on the top surface 210 of the device and/or mat 104 may include bright colors for the text and/or arrows (e.g., arrows 222, 224) that are visually displayed on the top surface 210 of the device and/or mat 104. It is preferable that the top surface 210 and/or bottom surface 212 of the device 104 may include rubber so as to prevent slipping and keep the mat 104 in place on the floor 220.

FIG. 3 shows an example of a user stepping on the top surface 210 of the mat 104 with the user's foot 302. The user is shown stepping on the “DOWN” indicia 110 and down arrow button 224 area of the mat 104. The act of stepping on this portion of the mat 104 is meant to call the elevator 102 and to activate the “down” push button 120 located on the elevator call box 118 and a corresponding push button 206 on the hall station box 132. By stepping on the mat 104 in this portion of the mat 104, the user controls the elevator 102 to come to the user's floor level and to descend to a lower floor. As noted above, the “UP” or “DOWN” arrows 222 and 224 and other associated indicia 110 may be located above specific air chambers 112. When the user steps on the arrows 222 or 224 or indicia 110 with his or her foot 302, the user is causing the air chamber 112 to depress and any air in that air chamber 112 travels from the air chamber 112, through an air outlet 114, through an attached air hose 116, up to the appropriate electrical contact 126 in a mounted electrical call box 124. The air toggles the electrical contact 126 to a momentary closed position, which activates or toggles the connected push button 120 in the existing elevator call box 118 and causes the elevator 102 to perform the intended function. When the user steps off of the mat 104, the air chamber 112 expands again and fills with air. Once the push button 120 has been depressed via the connected wires from the electrical contact box 124, the electrical contact 126 may toggle back to its normally open position.

FIG. 4 shows an example of a mat 104 that may include indicia 110 with numbers on the top surface 210 of the mat 104. The numbers shown on the mat 104 in FIG. 4 may indicate a specific floor that a user may travel to by stepping on the particular portion of the mat 104 having the desired floor level number. As shown in FIG. 4, a panel 402 of the elevator call box 118 is displayed on an interior wall of the elevator 102. The elevator panel 402 may include a number of push buttons 120 for controlling the elevator 102 including the floor number push buttons 120. The push button 120 on the panel 402 with the number “1” is illuminated in FIG. 4 in order to indicate that the user has stepped on the number “1” of the mat 104 and caused the push button 120 of the elevator call box 118 to be activated, thus causing the elevator to move to the first floor of the building.

In addition to the floor push buttons 120, the elevator panel 402 may include additional buttons such as the “open door” push button 404 and the “close door” push button 406. While not shown in FIG. 4, in one or more non-limiting embodiments, a mat 104 may include indicia 110 with arrows or text to indicate that the user may step on that portion of the mat 104 to hold open an elevator door or to close an elevator door. This feature may be particularly useful as users often need to hold the elevator doors to allow others to enter or exit the elevator 102, and they can also use the “close door” portion of the mat 104 to close the door of the elevator 102 in one or more embodiments.

FIG. 5 shows a mat 104 having a single “UP” arrow 222. As discussed above, there may be a single air chamber 112 located within the body 106 and the interior cavity 108 of the mat 104 in order to move to an upper floor of the building that the mat 104 is located in. This may be useful because some floors are terminal floors of a building, meaning these terminal floors are either the lowest floor or the highest floor in the building to which the elevator 102 can travel. As shown in FIG. 5, the hall station box 132 located on an exterior wall of the elevator hoistway 130 features only a single “UP” arrow 222 and the word “UP” to visually indicate to the user that they may only travel to a floor located above the floor that the user is located on. Accordingly, when located on the terminal floors of the building, in one or more non-limiting embodiments, the mats 104 may include only an “UP” or “DOWN” arrow 222 or 224 or other indicia 110 in order to move to a higher or lower floor. On the intermediate floors, where it is possible to move to either a lower floor or a higher floor, the mats 104 may include both the “UP” and “Down” arrows 222 and 224 or other indicia 110, as shown in FIGS. 2-3, because the mat 104 allows the user to control the elevator 102 and either ascend or descend to another floor as needed.

As shown in FIG. 5, the mats 104 featuring only a single function may be narrower in their width than other devices 104 having multiple functions and more indicia 110 and/or arrows, so as to take up less space when placed on the floor 220 in front of the elevator 102 and/or walls of the elevator hoistway 130.

Accordingly, it should be apparent from FIGS. 2-5 that the appearance and functions of the device 104 in relation to the elevator 104 can be customized and varied. Some devices 104 may include connections to the floor number push buttons (whether located on the elevator call box 118 or hall station box 132 or both) of the elevator 102 solely, while other devices 104 may include a combination of connections that can connect to the “UP” and “DOWN” push buttons of the elevator 102, the “open door” or “close door” push buttons of the elevator, as well as the floor number push buttons. Further, the devices 104 may include all of the appropriate indicia 110 to indicate which functions of the elevator 102 are controllable via the device 104.

While the embodiments described above for the device 104 specify that the device 104 includes air activated air chambers 112, other means of triggering the controls (e.g., push buttons 120) of the elevator 102 may be used in alternative embodiments. For example, in other embodiments, the device 104 may include push buttons on the top surface 210 of the device 104 that can be coupled to the push buttons 120 for an elevator call box 118 and/or hall station box 132, and the user may step on the push buttons on the top 210 of the device 104 to control the movements of the elevator 102.

As noted above, FIG. 6 shows a device having a first portion 602 and a second portion 603. The first portion 602 has a bulbous piece that covers the air chamber 112 and that the user is intended to step on with the user's foot in order to allow air to flow through the air chamber 112 and to the connected air hose 116 as shown in FIG. 6. The first portion 602 may be used to call an elevator to travel up one floor and includes indicia 110 of traveling up a level in a building using the elevator 102 associated with the device 104. This indicia 110 includes an up arrow as shown in FIG. 6 and further includes the words “UP CALL.” FIG. 6 further shows a second portion 603 for calling an elevator to travel down one floor and includes indicia 110 of traveling down Accordingly, the air chamber 112 for second portion 603 includes a down arrow and the words “DOWN CALL.” Each device 104 includes its own air hose 116 as shown in FIG. 6.

FIG. 7 shows an example of a device 104 (e.g., portion 602) for calling an elevator 102 to travel up one floor of a building. As shown in FIG. 7, the device 104 is located in front of an exterior wall of an elevator 102 and just below the elevator hall station box 132.

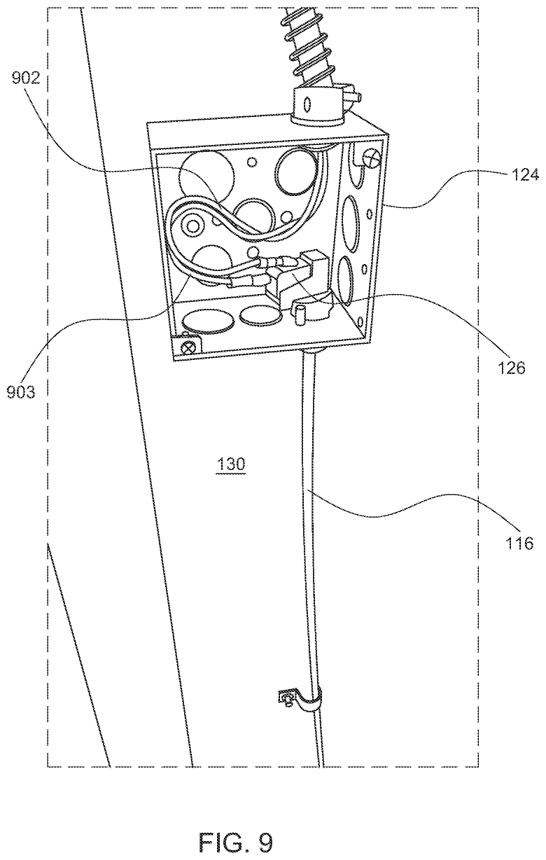

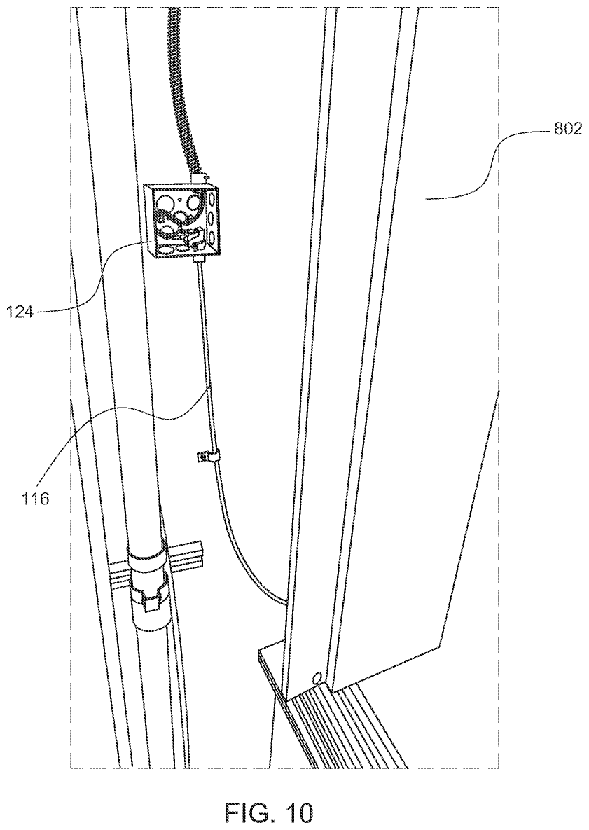

FIG. 8 shows the air hose 116 of the device 104 in FIG. 7 extending through the interior portion of the elevator hoistway 130. A user may need to drill a hole or opening in a lower portion of the exterior wall of the elevator hoistway 130 and extend the air hose 116 up through the interior wall of the elevator hoistway 130 to the electrical contact box 124 shown in FIG. 8. The electrical contact box 124 in FIG. 8 is shown with the front cover of the electrical contact box 124 in place while FIG. 9 and FIG. 10 shows the front cover of the electrical contact box 124 removed such that the interior of the electrical contact box 124 is visible. As shown in FIG. 9 and FIG. 10, there are internal wires 902, 903 connecting the electrical contact 126 to another cable that travels from an outside of the electrical contact box 124 to the elevator call box 118. As noted above, every landing 802 has an electrical contact box 124 that communicates electrical signals from the hall station box 132 through the electrical contacts 126 of the electrical contact box 124 to the elevator call box 118. The device 104, as disclosed herein, is designed to also connect with the electrical contact box 124 and communicate via air with the electrical contacts 126 in order to trigger and control a particular elevator function 122.

FIG. 9 shows the air hose 116 connected to the underside of the electrical contact box 124 and traveling through the interior of the electrical contact box 124. The exit outlet or exit of the air hose 116 is connected to the electrical contact 126 shown in FIG. 9. The air expelled from the air chamber 112 travels through the air hose 116 and causes a switch on the electrical contact 126 to be activated, thereby causing a transmission of electrical signal from the electrical contact 126 via wires 902, 903 in the electrical contact box 124 shown in FIG. 9 to transmit to the respective button 120 in the elevator call box 118 and to cause a particular elevator function 122 to occur. In this manner, the device 104 offers an alternative control mechanism to control the particular elevator function 122 and allows the user to call the elevator 102 to a particular landing (e.g., landing 802 shown in FIGS. 8-9), whereby the instruction has already been communicated to the elevator call box 118 for the particular elevator function 122 to occur. Accordingly, when the elevator 102 arrives at the landing 802 and the doors open and the passenger steps inside, the particular push button 120 associated with the particular function 122 (e.g., going up a floor or down a floor or to a particular floor with a particular floor number or another function) is highlighted and illuminated on the push button 120 in one or more non-limiting embodiments.

FIGS. 2-10 show examples of an elevator calling (foot activated) device 104 that is positioned outside of or exterior to the elevator 102. Accordingly, the air hoses 116 are configured to pass through a wall or floor surface of the elevator hoistway 130, to one or more electrical contact boxes 124, and to the one or more electrical contacts 126 disposed within the electrical contact boxes 124, and then an electric signal is sent to the elevator call box 118.

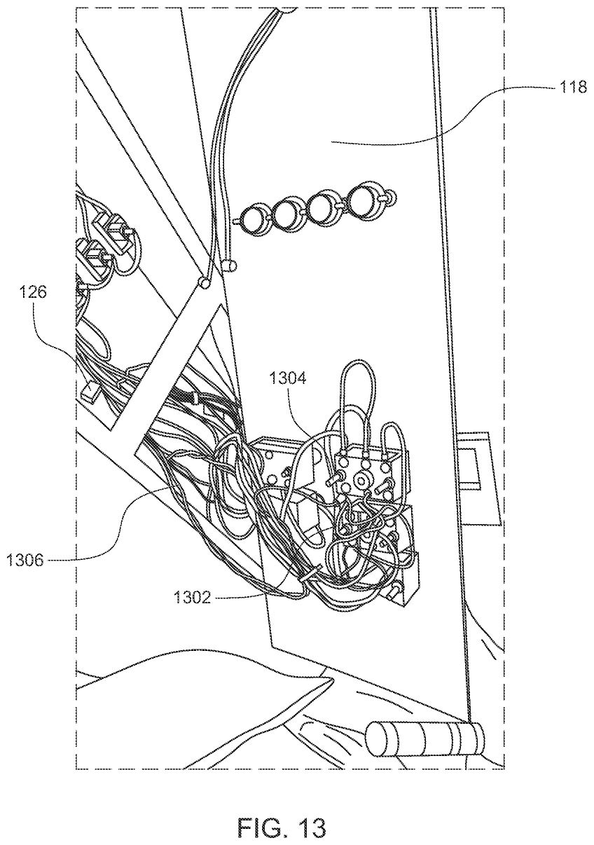

FIGS. 11-13 show an example whereby the elevator calling device 104 is positioned within the elevator 102 and thereby the electrical contacts 126 are disposed within the interior of the elevator call box 118 panel, as shown in FIG. 13. In FIG. 11, the elevator calling device 104 is located internally within an elevator 102 and placed or otherwise attached to a floor 1106 of the elevator 102 and proximate to the internal facing wall 1108 of the elevator 102. In other embodiments, the device 104 may be mounted or attached to a wall surface of the elevator 102.

As shown in FIG. 11, the elevator call box 118 is located on the same wall 1108 of the elevator 102 that the elevator calling device 104 is placed in front of in this example. In other examples, the elevator calling device 104 may be placed farther from the wall 1108 of the elevator call box 118 or placed facing another wall.

The elevator calling device 104 shown in FIG. 11 is a continuous unit having two separate partitions 1102, 1104 that enclose their respective air chambers 112. The first partition 1102 is configured to be used to allow a user to step on or otherwise activate the air chamber 112 of partition 1102 in order to travel to the first floor of the building that the elevator 102 is located in. FIG. 11 shows that 122a is the particular function associated with the push button 120 for the first floor on the elevator call box 118. The second partition 1104 is configured to be used to allow a user to step on or otherwise activate the air chamber 112 of partition 1102 in order to travel to the second floor of the building that the elevator 102 is located in. FIG. 11 shows that 112b is the particular function associated with the push button 120 for the second floor on the elevator call box 118. As shown in FIG. 11, the number “1” is visibly shown beneath the partition 1102 on the elevator calling device 104 and serves as indicia 110a to indicate to the user that the user may step on or otherwise activate that pedal/button/partition 1102 in order to travel to the first floor of the building in the elevator 102. Similarly, the number “2” is visibly shown beneath the partition 1104 on the elevator calling device 104 and serves as indicia 110b to indicate to the user that the user may step on or otherwise activate that pedal/button/partition 1104 in order to travel to the second floor of the building in the elevator 102.

The air hoses 116a, 116b (e.g., as shown in FIG. 12) that are connected to the elevator calling device 104 from a front portion of the device 104 are passed through the wall 1108 and/or floor 1106 of the elevator 102 to the backside 1204 of the elevator call box 118, which is shown in FIG. 12.

FIG. 12 shows the point of passage 1202 where the air hoses 116a and 116b for each of the first portion 1102 and second portion 1104 of the device 102 shown in FIG. 11 travel through the floor 1106 and/or one or more walls 1108 of the elevator 102 and connect with the air hoses 116a, 116b up to the backside 1204 of the elevator call or car station box 118 behind that interior wall of the elevator 102 (whereby the front side of the elevator call box 118 is on the opposite side of wall 1204 and located inside the elevator 102).

FIG. 12 shows that there can be multiple air hoses 116a, 116b that extend from a single foot activated device 104 through the point of connection 1202. One of ordinary skill may use drilling tools or other tools to make the necessary openings in the floor 1106 and/or walls 1108 of the elevator 102 in order to connect the air hoses 116a, 116b to the backside 1204 of the elevator call box 118 (or to the electrical contact box 124 as would be the case of the foot activate device 104 is located externally from the elevator 102 and not within the elevator 102). This is how the system may work, in one or more non-limiting embodiments, when the elevator calling device 104 is located within the elevator 102 versus when the elevator calling device 104 is located or positioned outside of the elevator 102 (e.g., such as that shown in FIGS. 2-10).

FIG. 13 shows the front panel of the elevator call box 118 in the elevator 102 removed with the various wires and cables 1306 that function to transmit electrical signals to the push buttons 120 of the elevator 102 so as to control particular functions 122. Further, one or more electrical contacts 126 are positioned inside of the elevator call box 118 (as opposed to be placed in the electrical contact box 124). The wires 1306 are provided in a manner that they extend from the electrical contact 126 to the activator piece 1302 for the push button 122a, as shown in FIG. 11, and to the activator piece 1304 for the push button 122b, as shown in FIG. 11 also. The air transmitted from the elevator calling device 104 is transmitted through the air hoses 116a, 11b, as shown in FIG. 12, to the electrical contact 126 placed in the elevator call box 118. Depending on which partition 1102, 1104, the user steps on with his or her foot or other object, the air from that particular partition 1102, 1104 will travel through its respective air hose (either 116a or 116b as shown in FIG. 12) to the electrical contact 126 which will then be toggled closed momentarily in order to send an electrical signal to the specific push button 122a and 122b associated with each partition 1102, 1104. The wires/cables 1306 shown in FIG. 13 may receive electrical signals the one or more electrical contacts 126 which are coupled to the elevator calling device 104 and its air chambers 112.

According to one or more non-limiting embodiments, a method for calling the elevator 102 shown in FIG. 1 may incorporate using an elevator calling (foot activated) device 104. The method may further include providing an elevator calling (foot activated) device 104 having at least one air chamber 112 that may be enclosed by an accessible exterior piece (e.g., 602, 603 in FIG. 6). The accessible exterior piece may project and have a unique form or may be flat and not have a projecting high profile (e.g., such as the partitions shown for each air chamber 112 in FIGS. 2-5 for the flatter device/mat 104). The method may further include depressing with a user's foot or other element the accessible exterior piece in order to cause air from the at least one air chamber 112 to travel to an associated air outlet 114 of the device to an air hose 116. Responsive to depressing the at least one air chamber 112 and causing the air from the air chamber to travel to the associated air outlet 114 of the device, flowing air from the associated air outlet 114 through at least one air hose 116. The air outlet 114 may be continuous with the entrance of the air hoses(s) 116 in some embodiments or may connect with multiple fasteners, separate elements in other embodiments.

The method may further include flowing the air through the at least one air hose 116 and to an electrical contact 126 that is coupled with a button 120 in an elevator call box 118 of the elevator 102. The electrical contact 126 is air activatable. Further, the electrical contact 126 may be disposed in the electrical contact box 124 when the device 102 is located external to the elevator 102. In other embodiments, when the device 104 is located within the elevator 102, the electrical contact 126 may be disposed within the elevator call box 118. The method may further include electrically communicating a signal from the activated electrical contact 126 with a button 120 of the elevator call box 118 of the elevator 102, wherein the button 120 of the elevator call box 118 controls a particular function 122 of the elevator 102. The method may further include positioning the device 104 on or attaching the device 104 to a floor or wall surface in front of or proximate to an exterior portion or wall of the elevator or to an interior portion of a floor or wall of the elevator 102.

Many apparent advantages are offered by the elevator calling device 104 as described in one or more non-limiting embodiments in the present description. Such elevator calling devices 104 may be foot operated and may help users of the elevators 102 whose hands are full and have a difficult time selecting the push buttons to control the elevator 102 with their fingers. Further, the elevator calling device 104 can help avoid transferring germs, bacteria, viruses, and the like to one's hands as such harmful microorganisms and other undesirable elements tend to stay on the surface of the push buttons 120 of an elevator 102. Thus, using the elevator calling device 104 may help minimize and prevent spreading infection to multiple people. Many other advantages and benefits may be offered by the one or more non-limiting embodiments of the system as described above.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A device for calling an elevator, the device comprising:
a body having a top surface and a bottom surface;
one or more air chambers incorporated into the body of the device, wherein each air chamber relates to a specific function of one or more functions of the elevator, wherein the one or more air chambers are enclosed partitions configured to serve as pedals or buttons that call and/or control the one or more functions of the elevator;
one or more indicia that is visible on the top surface of the device having visible markings to indicate that an air chamber of the one or more air chambers is associated with a particular function of the one or more functions; and
one or more air hoses, wherein the device is configured to allow air from the one or more air chambers to exit the one or more air hoses in order to call and/or control the one or more functions of the elevator,
wherein the one or more air chambers is configured to be activated by a stepping action of a foot or by another force applied to the one or more air chambers from another object or element.

2. The device of claim 1, wherein each air chamber of the one or more air chambers has a particular air hose of the one or more air hoses coupled to each air chamber.

3. The device of claim 1, wherein the device is configured to be placed or attached to a floor surface or a wall surface proximate to an exterior or interior of the elevator.

4. The device of claim 1, wherein the device is a continuous unit with multiple separated, enclosed air chambers for controlling multiple functions of the elevator.

5. The device of claim 1, wherein the device comprises a single, enclosed air chamber configured to control a single function of the one or more functions.

6. The device of claim 1, wherein the one or more indicia comprise visible text, symbols, or other images conveying visual meaning about the one or more functions associated with calling and/or controlling the elevator that can be selected using the device.

7. The device of claim 1, wherein the device is a mat that can be placed on or otherwise attached to a floor surface or a wall surface.

8. A system for calling an elevator using a device, the system comprising:
the elevator, the elevator comprising:
an elevator call box comprising one or more buttons, wherein the elevator is disposed within an elevator hoistway;
a device configured to be placed or attached to a floor surface or a wall surface proximate to an interior or exterior of the elevator, wherein the device further comprises:
a body having a top surface and a bottom surface;
one or more air chambers incorporated into the body of the device, wherein each air chamber relates to a specific function of the one or more functions, wherein the one or more air chambers are enclosed partitions configured to serve as pedals or buttons that call and/or control the one or more functions of the elevator;
one or more indicia that is visible on the top surface of the device having visible markings to indicate that an air chamber of the one or more air chambers is associated with a particular function of the one or more functions; and
one or more air hoses, wherein the device is configured to allow air from the one or more air chambers to exit the one or more air hoses in order to control the one or more functions of the elevator,
wherein the one or more air chambers is configured to be activated by a stepping action of a foot or by another force applied to the one or more air chambers from another object or element; and
one or more electrical contacts disposed within an electrical contact box or within an elevator call box, wherein the one or more electrical contacts are electrically coupled to the one or more buttons of the elevator call box,
and wherein the one or more electrical contacts are configured to toggle open or close and are air activatable,
and wherein the one or more buttons in the elevator call box in the elevator are associated with the one or more functions that are operable using the device.

9. The system of claim 8, wherein the indicia comprise visible text, symbols, or other images conveying visual meaning about the one or more functions associated with controlling the elevator that can be selected using the device.

10. The system of claim 8, wherein each air chamber of the one or more air chambers has a particular air hose of the one or more air hoses coupled to each air chamber.

11. The system of claim 8, wherein the device is a continuous unit with multiple separated air chambers for controlling multiple functions.

12. The system of claim 8, wherein the device comprises a single air chamber configured to control a single function of the one or more functions.

13. The system of claim 8, wherein when the device is placed exterior to the elevator, the one or more electrical contacts are disposed within the electrical contact box and the one or more air hoses connects each air chamber of the device to the one or more electrical contacts within the electrical contact box.

14. The system of claim 8, wherein when the device is placed within an interior of the elevator, the one or more electrical contacts are disposed within the elevator call box and the one or more air hoses connects each air chamber of the device to the one or more electrical contacts within the elevator call box.

15. The system of claim 1, wherein the one or more functions associated with calling and/or controlling the elevator comprise ascending, descending, selecting a specific floor to travel to, opening, and/or closing a door of the elevator.

16. The system of claim 8, wherein the one or more buttons of the elevator are tangible, physical items or are digital representations.

17. A method for calling an elevator using a device, the method comprising:
providing a device having at least one air chamber with an accessible exterior piece for depressing with a user's foot or other element in order to causing air from the at least one air chamber to travel to an associated air outlet of the device;
responsive to depressing the at least one air chamber and causing the air from the air chamber to travel to the associated air outlet of the device, flowing air from the associated air outlet through at least one air hose;
flowing the air through the at least one air hose and to an electrical contact that is coupled with a button in an elevator call box of the elevator, wherein the electrical contact is disposed within an electrical contact box exterior to the elevator or within an elevator call box within the elevator, wherein the electrical contact is air activatable; and
electrically communicating a signal from the activated electrical contact with a button of the elevator call box of the elevator, wherein the button of the elevator call box controls a particular function of the elevator.

18. The method of claim 17, wherein the device is positioned on or attached to a floor or wall surface in front of or proximate to an exterior portion or wall of the elevator.

19. The method of claim 17, wherein the device is positioned on or attached to a floor or wall surface in front of or proximate to an interior portion or wall of the elevator.

20. The method of claim 17, wherein the device further comprises one or more indicia, wherein the one or more indicia comprise visible text, symbols, or other images conveying visual meaning about the one or more functions associated with controlling the elevator that can be selected using the device.
